(19) United States
(12) Patent Application Publication
(10) Pub. No.: US 2018/0082017 A1
(43) Pub. Date: Mar. 22, 2018

(54) METHOD AND APPARATUS FOR INFORMATION RETRIEVAL

(71) Applicant: HELSINGIN YLIOPISTO, Helsingin Yliopisto (FI)

(72) Inventors: Manuel EUGSTER, Helsingin Yliopisto (FI); Tuukka RUOTSALO, Helsingin Yliopisto (FI); Michiel SOVIJÄRVI-SPAPÉ, Helsingin Yliopisto (FI); Giulio JACUCCI, Helsingin Yliopisto (FI); Samuel KASKI, Aalto (FI); Niklas RAVAJA, Helsingin Yliopisto (FI); Oswald BARRAL, Helsingin Yliopisto (FI)

(21) Appl. No.: 15/271,437

(22) Filed: Sep. 21, 2016

(51) Int. Cl. G06F 19/00; G06F 17/30; G06N 99/00

(52) U.S. Cl. CPC G06F 19/321; G06F 17/30011; G06N 99/005; G06F 17/30268; G06F 17/30684

(57) ABSTRACT

This disclosure relates to methods and apparatus for generating criteria for information retrieval tasks. A quantifying unit is trained through machine learning to assign relevance values to functional brain imaging potentials measured from a person. This quantifying unit is then used when the person performs an information retrieval task by reading a primary document. The quantifying unit assigns relevance values to text items viewed by the person in the primary document. Based on these relevance values a criterion is generated for the information retrieval task, and potentially relevant secondary documents are retrieved from a document database based on whether or not, or to what extent, they meet this criterion.

### BACKGROUND

### Field

The present disclosure relates to functional brain imaging measurements performed on a person who is viewing words or reading text from a document. More particularly, the person in question is performing an information retrieval task, and the method and apparatus described in this disclosure generate task-specific information retrieval criteria without explicit input from the person concerning task objectives. The criteria are based on relevance values which are specific to primary text items in a primary document which the person views. The relevance values are assigned based on functional brain imaging potentials measured from the person at a moment when the person views the primary document.

The present disclosure further relates to the assignment of relevance values to additional, secondary text items. These secondary text items are not viewed by a person, but relevance values are assigned based on their co-occurrence with primary text items in a set of secondary documents. The present disclosure also relates to a recommender system which utilizes the task-specific information retrieval criteria to recommend potentially relevant secondary documents to the person.

### Brief Description of the Related Art

Electronic documents on the World Wide Web and other information sources are a central resource in our daily life. Information retrieval is a central task for every reader of electronic documents, but it can be difficult for readers to locate the most relevant information in a large collection of documents only by feeding keywords to a search engine. Computational recommender systems have therefore been introduced to help users find relevant information more easily. To predict the needs and intentions of a user, recommender systems often rely on histories of previous searches and other online behavior. Such recommender systems are most effective if explicit feedback can be obtained from the user with regard to the usefulness of each recommendation, but many users are reluctant to provide explicit feedback if it involves extra work.

It would therefore preferable to use recommender systems with automated feedback, i.e. systems where user intents are determined or estimated without burdening the user with questions. One way to obtain automated feedback is to monitor functional brain imaging signals, such as electroencephalographic (EEG) or magnetoencephalographic (MEG) signals, measured from the user as he or she tries to locate information.

Functional brain imaging measurements on persons viewing visual media have previously been used for studying how test subjects respond to image-based advertising. Document WO2008108799 discloses a method for categorizing and scoring visual media events based on functional brain imaging signals measured from viewers as they view the media. The visual media comprise images of different sorts.

Document US2009062679 discloses a perceptual stimulus categorization technique which identifies the category of a perceptual stimulus presented to a person whose brain activity is being monitored with a functional brain imaging measurement. The stimuli presented in this document are also images, such as faces. Machine learning is used to train a detection module to categorize the various functional brain imaging potentials that the perceptual stimuli induce.

These prior-art disclosures are not applicable to information retrieval because the measured functional brain imaging potentials are not mapped to a relevance scale.

### SUMMARY

An object of the present disclosure is to provide a method and an apparatus for generating criteria for an information retrieval task through functional brain imaging measurements performed on a person who is viewing or reading text while searching for information. The measurements may involve electroencephalography (EEG), magnetoencephalography (MEG) or other measurement modalities.

The objects of the disclosure are achieved by a method and an apparatus which are characterized by what is stated in the independent claims. The preferred embodiments of the disclosure are disclosed in the dependent claims.

The disclosure is based on the idea of measuring the functional brain imaging potentials from the head of a person as she fixes her vision on a sequence of text items. When performing an information retrieval task, the person tries to locate information on a certain subject. He or she may have some degree of foreknowledge and certain preconceptions about the subject. Based on this foreknowledge and these preconceptions, the person has certain relevant keywords in mind.

This disclosure is based on the following discovery: functional brain imaging potentials measured from a person when he or she views text items which are relevant to the information retrieval task are consistently different from functional brain imaging potentials measured from the same person as he or she views text items which are irrelevant to the task.

Relevant text items may induce a change in functional brain imaging potentials for various reasons. The person may, for example, become more alert in the expectation that he or she could soon learn something new. The person may also focus more closely on relevant text items in the expectation that pointers to further information, such as literature references or internet links, may be found nearby. This disclosure will not discuss the possible reasons for differences caused by relevant and irrelevant text items in functional brain imaging potentials. Instead, the disclosure focuses on practical means for using this difference in recommender systems.

The monitoring of functional brain imaging potentials obtained from a person may involve some uncertainties if the person reads or skims through the text very quickly, or if the measurement is noisy for other reasons. However, functional brain imaging-based criteria generation can sometimes be supplemented with additional information about the topic at hand. All texts have a topic where certain words regularly occur in the same context. This means that the information gained from functional brain imaging measurements with regard to text item relevance may be supplemented with information about the topic vocabulary. If, for example, the measured functional brain imaging potentials indicate that primary text items such as “player”, “goal” and “pass” are relevant, then the secondary text item “ball” may also be considered relevant even if the person hasn't viewed it, because the common vocabulary of the apparent topic (sport) indicates that the text item “ball” is also likely to be relevant in this topic.

In other words, once a certain number of primary text items have been designated as relevant, the topic, or at least a narrow range of possible topics, of this information retrieval task may be pinpointed. The relevance of secondary text items which have not been viewed by the person can then be estimated through their membership or non-membership in the vocabulary of the(se) topic(s).

In this disclosure the attribute “primary” refers to text items and documents viewed by the person when he or she performs an information retrieval task and a functional brain imaging-measurement is performed. The attribute “secondary” refers to any other text items and documents.

Criteria for information retrieval may be generated directly from the measured functional brain imaging potentials, but optionally also by studying the co-occurrence of primary text items and other text items in a set of secondary documents.

If the person performing the information retrieval task views a large part of a primary document on a screen, many text items will be visible to the person simultaneously. Eye-tracking measurements may then be required to connect a measured set of functional brain imaging potentials to a given primary text item in the document.

When relevance values have been estimated for a sufficiently large number of primary text items, and optionally secondary text items as well, a recommender system which utilizes the generated search criteria can be implemented. The method presented in this disclosure can be used to rank secondary documents. The highest ranked secondary documents can then be recommended to the person as potentially relevant documents which may contain more information about the subject he or she is interested in.

The methods and apparatus presented in this disclosure can be utilized for any application where a person's subjective perception of word relevance is of interest. The advantage of the method and apparatus presented in this disclosure is that criteria for information retrieval can be generated without disturbing the user with feedback requests or other conscious input. Instant feedback on the relevance of specific text items can be obtained through the measured functional brain imaging signal without placing a burden on the user.

### BRIEF DESCRIPTION OF THE DRAWINGS

In the following the disclosure will be described in greater detail by means of preferred embodiments with reference to the accompanying drawings, in which

FIG. 1 is illustrates a method according to a first embodiment.

FIG. 2 illustrates an apparatus according to the first embodiment.

FIG. 3 illustrates a method according to a second embodiment.

FIG. 4 illustrates an apparatus according to the second embodiment.

### DETAILED DESCRIPTION

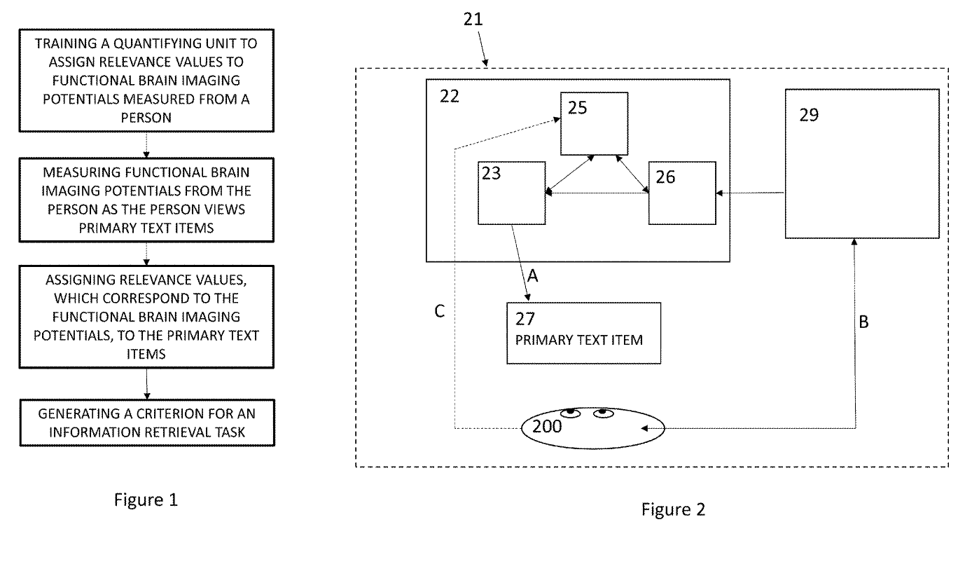

FIG. 1 schematically illustrates a method according to the first embodiment.

This embodiment relates to a method where a quantifying unit is trained through machine learning to assign relevance values to functional brain imaging potentials measured from a person. The method comprises measuring functional brain imaging potentials from the person as the person views primary text items of a primary document and assigning in the quantifying unit relevance values, which correspond to the functional brain imaging potentials, to the primary text items of the primary document. The method also comprises generating a criterion for an information retrieval task from the primary text items and their assigned relevance values.

In this disclosure the term “functional brain imaging potentials” is used as a general term for measurement results obtained in a functional brain imaging measurement. In the case of EEG, electric potentials may be measured from electrodes attached directly to a test subject. In the case of MEG, the potentials may be measured from magnetic sensors which may convert the sensed magnetic field into a measurable electric potential. The term “functional brain imaging potentials” will be used in the plural form because EEG and MEG measurements may involve a multitude of electrodes and sensors.

FIG. 2 schematically illustrates an apparatus according to the first embodiment. An electroencephalographic (EEG) measurement device will be described, but the method and apparatus could also be implemented with a magnetoencephalographic device, as mentioned above.

The apparatus is configured to generate a criterion for an information retrieval task with the above method. The apparatus 21 comprises an EEG measurement device 29 for recording EEG potentials. The apparatus 21 also comprises a computer with a control unit 22. The control unit 22 may comprise a memory unit 23. The control unit 22 may retrieve a primary document from memory unit 23 and display it on the screen 27 to the viewing person 200 (as indicated by arrow A). The person 200 may view primary text items from the primary document while EEG measurement device 29 records EEG potentials (arrow B).

In this disclosure the term “document” means a document in electrical form which may comprise text and figures. The document may be presented on a screen 27, which may be a screen in a computer, television, digital phone or any other device suitable for reading electronic documents.

The control unit 22 may comprise one or more data processors. The control unit may comprise a memory unit where computer-readable data or programs can be stored. The memory unit may comprise one or more units of volatile or non-volatile memory, for example EEPROM, ROM, PROM, RAM, DRAM, SRAM, firmware or programmable logic.

When training the quantifying unit, the primary document may be displayed on the screen 27 one primary text item at a time. This can increase the accuracy and thereby reduce the duration of the training process. In other words, instead of showing a large part of the document to person 200, with large blocks of text simultaneously visible, the primary text items may be picked from the document one by one, so that each viewed primary text item disappears from the screen before the next one is displayed. The primary text items may be single words, but they may alternatively be longer expressions such as word pairs, triplets or even entire sentences.

The EEG device 29 comprises means for performing an EEG measurement. These means may, for example, include 10-50 Ag/AgCl electrodes, positioned on an elastic cap. The person may wear the cap on his or her head when the measurement is conducted. A separate signal may be measured from each electrode, so the number of electrodes corresponds to the number of measurement channels.

The control unit 22 may filter the signal measured from the EEG apparatus in a filtering unit 26, for example with a 35 Hz FIR1 low-pass filter and a 0.5 Hz high-pass filter. The filtering unit 26 may also remove invalid EEG measurement data by discarding data from measurement channels where the variance during a time period falls below a first threshold. This first threshold may, for example, be 0.5 μV. The filtering unit 26 may also discard data where the difference between the maximum value and the minimum value falls below a second threshold. This second threshold may, for example, be 40 μV. This data cleaning approach is useful not only for eliminating measurement noise, but also for excluding data which has been recorded when the person closed her eyes or blinked.

In this disclosure, the quantifying unit 25 may be implemented with a computer program product executed on a processor in control unit 22. The quantifying unit 25 may be trained through machine learning to assign relevance values to EEG potentials measured from the person 200. It should be noted that although the EEG potentials induced by relevant text items are consistently different from the EEG potentials induced by irrelevant text items, this difference is complex. In other words, the difference is usually not directly reducible to any numerical variable which could be calculated from the EEG potentials. The difference is also idiosyncratic—it varies from person to person.

Machine learning may for this reason be advantageously applied to train the quantifying unit 25 to interpret patterns in the EEG potentials obtained from the person 200. Many supervised, unsupervised or semi-supervised machine learning methods could be applied for this task. The supervised method described below is only exemplary.

In the training process, the person 200 is instructed to imagine that he or she is performing an information retrieval task on a specific subject. A primary document with a suitable text (that is, a text which seems to contain text items which could be considered relevant to this subject) is then retrieved from memory unit 23 is then shown, preferably one text item at a time, to the person 200. An EEG measurement is conducted simultaneously. The person 200 may be asked to rate the relevance of each shown text item (arrow C in FIG. 2). With the help of this feedback, quantifying unit 25 can, through repeated measurement and feedback, learn to assign an approximate numerical relevance value to the EEG potentials measured from person 200 as the person views text items.

The calculations in the supervised machine learning process may, for example, be based on linear discriminant analysis (LDA) and learned linear binary classifiers which are used to predict class membership probabilities. It may be assumed that the observations have been drawn from two multivariate normal distributions, one for the class of relevant observations, and the other for the class of irrelevant observations. The training process may utilize shrinkage LDA, a covariance-regulated LDA with a shrinkage parameter.

Once the training process is finished, quantifying unit 25 can assign relevance values to EEG potentials measured from person 200 without supervision and corrective feedback. The method according to the first embodiment can then be implemented with the apparatus shown in FIG. 2. The person 200 may in this case perform an information retrieval task on an unknown subject, and begins the retrieval by selecting a primary document. As the primary document is shown to person 200 on the screen, control unit 22 may be configured to store in memory unit 23 each primary text item with a timestamp which indicates the time when the person 200 viewed this primary text item. Control unit 22 may also store in memory unit 23 the relevance value which quantifying unit assigned to the EEG potentials which were measured at the times indicated by the timestamp. In other words, control unit 22 may generate a data set where primary text items are associated with corresponding relevance values.

From this data set, control unit can generate a criterion for an information retrieval task. This criterion can be generated in many different ways. The control unit may, for example, generate the criterion by creating a set of primary text items where only those text items whose relevance values exceed a certain threshold are included. This set may be called a criterion set and it may be stored in memory unit 23. When information is retrieved, the retrieval criterion for a given set of secondary documents may be that every retrieved secondary documents should include all text items stored in the criterion set. The retrieval criterion may also be that every text item from the criterion set should appear with a certain frequency in the secondary documents which are retrieved. The frequency requirement associated with each text item in the criterion set may be depend the relevance value of that text item. The person skilled in the art will recognize that numerous other criteria for information retrieval could also be generated from a data set which includes text items and associated relevance values.

The steps in the method of the first embodiment may be temporally and spatially separated. In other words, the training of quantifying unit 25 does not have to take place just before the criteria for the information retrieval task are generated. When a quantifying unit has been trained to assign relevance values to the EEG potentials measured from a certain person, the same quantifying unit can be used to assist this person in many information retrieval tasks, some of which may take place a long time after the quantifying unit was trained. In other words, the quantifying unit but does not have to be before every information retrieval task, and it does not have to be trained repeatedly. Even so, it may in some cases be beneficial to conduct a new training session if a long time has elapsed since the previous one.

The methods described in this disclosure may also be implementable with, for example, skin conductivity measurements instead of functional brain imaging measurements such as EEG or MEG.

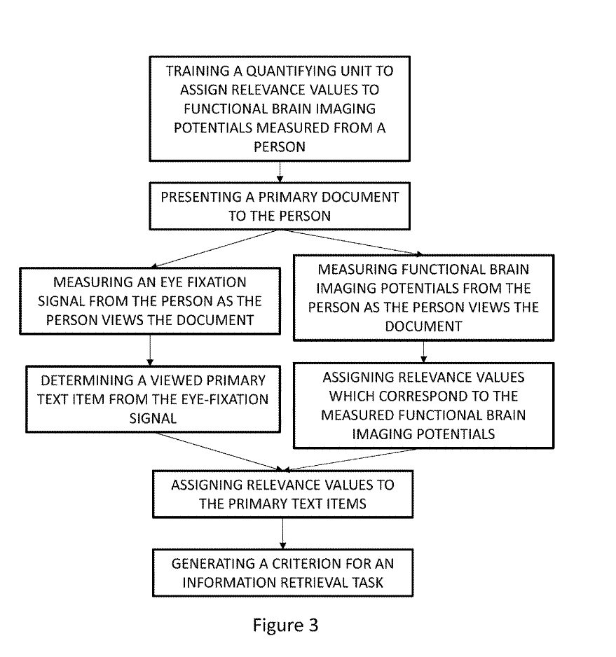

FIG. 3 illustrates a method according to a second embodiment. This method comprises the steps of the first embodiment, but the training step has been omitted for clarity. The method comprises the additional steps of measuring an eye fixation signal from the person as the person views the primary document and determining a viewed primary text item from the eye fixation signal.

This method concerns a situation where the person views a large portion of the primary document simultaneously and therefore reads or views the text by fixating her vision on text items in the document and moving the fixation point as she decides which parts to read or view. In order to generate criteria for an information retrieval task in this situation, the apparatus may determine which text item the person was viewing when specific functional brain imaging potentials was measured. The criteria can be generated by synchronizing an eye fixation signal and a functional brain imaging measurement signal.

In this disclosure the term “fixation signal” refers to a time-stamped data series, where the time-stamp indicates moments when an eye-tracking measurement was conducted. The data series also comprises text items from the document. The fixation signal indicates on which text item the person fixated her eyes at a given moment. If the person steadily read the text word by word, the fixation signal may comprise time-text item pairs where the text items are in the same order as in the document. If the person's gaze jumped back and forth in the text, the text items will be in a different order in the fixation signal. The person's gaze may also sometimes scan across the page too quickly to fixate on any given word, or it may be directed away from the screen. Some time-stamps in the fixation signal may therefore not be associated with any text item.

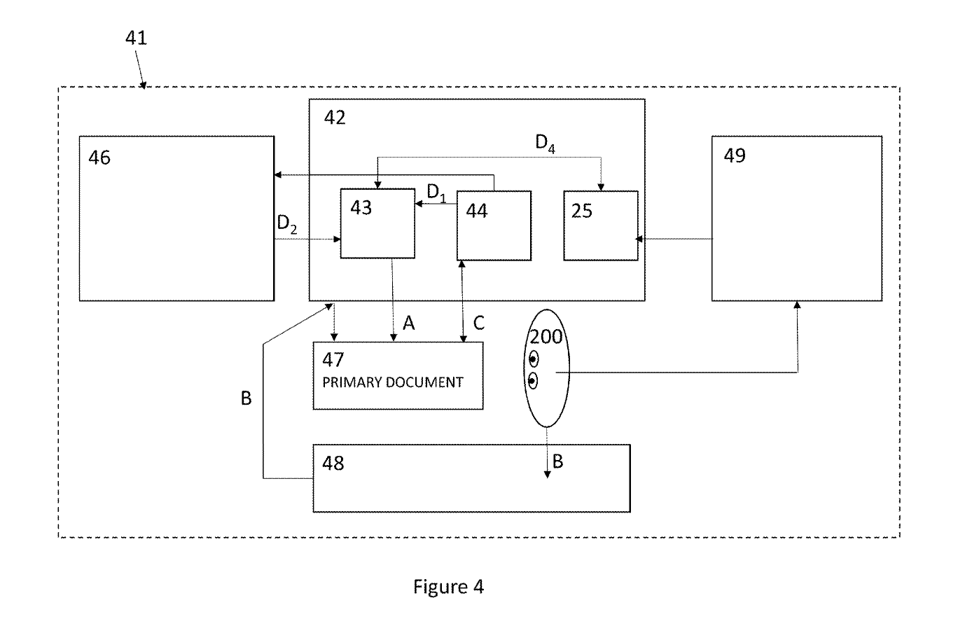

FIG. 4 schematically illustrates an apparatus according to the second embodiment. Again, an EEG measurement device will be described, but an MED device could also be used. The apparatus 41 generates a criterion for an information retrieval task performed by person 200 when the person views a primary document on the screen 47. The apparatus 41 comprises eye-tracking device 46 for producing a fixation signal and EEG measurement device 49 for producing an EEG potential signal. The EEG device 49 may have the same structure as EEG device 29 described above.

The apparatus 41 also comprises a computer with a control unit 42, which may correspond to the control unit 22 described above. The control unit may comprise a memory unit 43. The control unit 42 may retrieve the primary document from memory unit 43 and display it on the screen 47 to the viewing person 200 (as indicated by arrow A). With the help of a user interface 48 and control unit 42, the person 200 may scroll the text in the primary document up and down on the screen 47, or zoom the displayed portion in and out (arrow B). The user interface 48 may comprise a keyboard, a mouse, and/or other typical computer interface components.

The apparatus 41 may also comprise communication means for transferring data between control unit 42, eye-tracking device 46, EEG measurement device 49, user interface 48 and screen 47. These communication means may, for example, comprise a wireless data link such as, Bluetooth, Wifi, GSM/3G/4G, or a wired data link. The control unit 42 may be a part of a computer device, and the computer device may be integrated with either the eye-tracking device 46 or the EEG measurement device 49, or separate from both of them. The computer device may be a mobile phone, tablet computer, personal computer or the like, adapted to perform the methods of this disclosure. The same communication means and device integration may be applied in all embodiments in this disclosure.

The control unit 42 may comprise one or more data processors. The control unit 42 may comprise a memory unit 43 where computer-readable data or programs can be stored. The memory unit 43 may comprise one or more units of volatile or non-volatile memory, for example EEPROM, ROM, PROM, RAM, DRAM, SRAM, firmware, programmable logic, etc.

The control unit 42 may comprise a screen coordinator 44. The screen coordinator 44 may be a computer program product which is configured to divide the area of the screen 47 into a coordinate system and keep track of which primary text item is located at each coordinate as the user scrolls up and down or right and left, and/or zooms in and out in the primary document using user interface 48 (arrow C). In other words, with the help of the signal from the user interface 48 and screen coordinator 44, the control unit 42 may be configured to store in memory unit 43 a first data set D₁ which comprises (1) a timestamp, (2) a set of screen coordinates, which together may cover the entire screen, associated with each timestamp, and (3) for each timestamp and each screen coordinate, either the primary text item from the primary document which was located at this coordinate at the time indicated by the timestamp, or an indicator which indicates that no primary text item from the primary document was located at this coordinate at the time indicated by the timestamp.

The eye-tracking device 46 may be controlled by the control unit 42. The eye-tracking device 46 may comprise light-emitters, sensors and/or cameras for performing infrared-oculographic or video-oculographic measurements on the eyes of the person 200. The eye-tracking device 46 may also comprise other means for tracking the gaze of the person. Screen coordinator 44 may provide the coordinate system to the eye-tracking device. The control unit 42 may then be configured to obtain from eye-tracking device 46 a second data set D₂ which comprises (1) a timestamp, and (2) the screen coordinate on which the person's gaze was fixated at the time indicated by the timestamp. If, at the time indicated by a certain timestamp, the person's gaze was directed away from the screen, or scanning quickly across the page, the data associated with this timestamp may comprise an indicator which indicates that the person's gaze was not fixated upon any screen coordinate at the time indicated by the timestamp. The second data set D₂ may be stored in memory unit 43.

The control unit 42 may create the fixation signal by synchronizing and combining data from the first data set D₁ and second data set D₂ to produce a third data set D₃ which comprises (1) a timestamp, (2) primary text items from the primary document. At the time indicated by the timestamp, the person's gaze was fixated upon the primary text item which is indicated in the third data set D₃. In this context, synchronizing means that the data items associated with the same timestamp in the first and second data sets are grouped together under said timestamp in the third data set. The third data set D₃ is the fixation signal and it may be stored in memory unit 43.

The means for producing a fixation signal are familiar to a person skilled in the art from prior art documents WO2006100645, US2016224308 and/or US2016147298.

The primary text items may be single words, but they may alternatively be longer expressions such as word pairs, triplets or entire sentences. The control unit 42 may compare primary text items stored in the third data set to expression dictionaries or idiom dictionaries stored in the memory unit. If two or three words, which have been stored as primary text items with consecutive timestamps in the third data set, correspond to a two- or three-word expression or idiom in one of the dictionaries, then the control unit may substitute this expression for the consecutive (separate) words in the third data set.

The EEG potentials are obtained with electroencephalographic (EEG) measurement device 49, as described above.

Once the EEG measurement data has been filtered and invalid data has been removed (a filtering unit may be included in the apparatus FIG. 4, although it is not shown), the data may be transferred to the quantifying unit 25. As described above, quantifying unit 25 has been trained to assign a relevance value to each set of EEG potentials obtained from the person 200 whose information retrieval task the apparatus 41 is set to assist. A relevance value is a numerical value which expresses how relevant a viewed text item seemed to the person 200 who is performing an information retrieval task.

The control unit 42 obtains from quantifying unit 25 a fourth data set D₄ which includes a timestamp and the relevance value assigned by quantifying unit 25 to the EEG potentials measured at the time indicated by the timestamp. Control unit 42 may then obtain third data set D₃ and fourth data set D₄ from memory unit 43. By synchronizing these two data sets, in other words by pairing each primary text item from the third data set with the relevance value which has the same timestamp in the fourth data set, the control unit 42 may create a fifth data set D₅ where a relevance value is paired with each primary text item from the third data set D₃. In other words, in the fifth data set each primary text item viewed by person 200 is paired with a relevance value. If some primary text items have been viewed multiple times and the corresponding EEG potentials differ slightly from each other, that primary text item may be associated with many different relevance values in the fifth data set. The control unit 42 may check this and average all relevance values associated with a primary text item into one representative value.

In a third embodiment this disclosure relates to a method for ranking a first set of secondary documents according to their relevance. A quantifying unit may be trained in the manner described above, functional brain imaging potentials may be measured as the person views a primary document, and relevance values may be assigned to primary text items by the quantifying unit. A criterion for an information retrieval task may be generated in the manner described above. Based on this criterion, a relevance score may be determined for secondary documents in the first set, and the secondary documents in the first set are ranked based on their relevance scores.

An apparatus for performing this method may comprise the same elements as in the first or second embodiments. The control unit may be linked with a data connection to document databases on the internet for retrieving the first set of secondary documents.

It is evident to a person skilled in the art that secondary documents can be ranked and recommended with a multitude of different methods once a criterion for the information retrieval task has been established. The simple ranking and retrieval method described below, which is based only on the occurrence of text items in the secondary documents, is only exemplary. Other known measures and criteria of relevance, relating for example to cross-references, links or figures in the secondary documents, may be used to supplement and complement the criteria obtained through functional brain imaging measurements.

The control unit may implement the information retrieval task with using a unigram language modeling approach. The criterion generated from functional brain imaging measurements for the information retrieval task may for example be a weight vector r, which contains the relevance values of each primary text item. The vector r may be treated as a sample of a desired document, and the control unit may rank secondary documents dⱼ by the probability that r would be generated by the respective language model M_{dj} for the document dⱼ. M_{dj} determines the probability of the document to generate the primary text item.

Using maximum likelihood estimation, the control unit may calculate this probability as:

P(r|M_{d}_{ⱼ})=Πᵢ₌₁^{|r|}\hat{P}ₘₗₑ(kᵢ|M_{d}_{ⱼ})^{r}^{ᵢ} (1)

where kᵢ is a coefficient relating to the i:th text item, described below in relation to the fourth embodiment.

To avoid zero probabilities and improve the estimation, the control unit may compute a smoothed estimate by Bayesian Dirichlet smoothing so that

$${\hat{p}}_{mle} ( {k}_{i} \vert {M}_{{d}_{j}} ) = \frac{c ( {k}_{i} \vert {d}_{j} ) + μ p ( {k}_{i} \vert C )}{{\sum }_{k} c ( k \vert {d}_{j} ) + μ} \qquad ( 2 )$$

where c(k|dⱼ) is the count of text item k in document dⱼ, p(kᵢ|C) is the occurrence probability (proportion) of the i:th text item kᵢ in the whole document collection, and the parameter μ may be set to 2000.

The smoothed probabilities may be interpreted as relevance scores. These relevance scores are assigned to secondary documents in the first set based on the occurrence of primary text items in these secondary documents, and on the relevance values of said primary and secondary text items. The control unit may then rank the secondary documents in the first set according to their relevance scores, and present a recommendation comprising one or more documents with the highest relevance scores to the person performing the information retrieval task. The control unit may thereby function as a recommender system.

In a fourth embodiment, this disclosure relates to a method where a second set of secondary documents is indexed and relevance values are assigned to secondary text items in these secondary documents based on co-occurrence of primary and secondary text items in this second set of secondary documents. A relevance score may then be assigned to secondary documents in the first set based on the occurrence of both primary text items and secondary text items in the secondary documents of the first set, and on the relevance values of said primary and secondary text items.

An apparatus for performing this method may comprise the same elements as in the first, second and third embodiments. The control unit may be linked with a data connection to document databases on the internet.

When relevance values are used in recommender systems which help the person 200 in an information retrieval task, the efficiency of the recommender system depends on the number of primary text items in the fifth data set (the greater the number of text items, the more reliable the recommendation). It also depends on the discriminating power of these text items (common words, such as “the”, which occur very frequently in all English texts, have no discriminating power). It also depends on the associated relevance values (the larger the value(s), the more reliable the recommendation).

Therefore, depending on how many text items the person 200 has viewed, and depending on their relevance values and discriminating power, the fifth data set may or may not by itself constitute a sufficient basis for making reliable recommendations (generating reliable criteria) at any given moment. Control unit 41 may include various quality checks for evaluating whether not the fifth data set is sufficient. The quality check may, for example, be a calculation where the relevance values and term frequency-inverse document frequency (tf-idf) values associated with each text item are multiplied and/or across all text items. The quality check may also be restricted only to the 3-10 text items which have the highest relevance values and tf-idf values.

If the control unit determines in the quality check that the fifth data set is sufficient for reliable recommendations, it can proceed directly to the recommendation process described in the third embodiment. However, if the fifth data set is not sufficient by itself, the control unit may assign relevance values to additional text items with a search intent estimation model which predicts the topic of interest.

Both the quality check and the subsequent decisions are preferably undertaken on a continuous basis, or with short intervals. In other words, the quality check is not a singular event which is only performed at the end of an information retrieval task. It can be executed continuously. The fifth data set expands gradually as the person proceeds in her information retrieval task. The fifth data set may therefore initially be an insufficient basis for a recommender system, but later become sufficient as more data has been stored in the fifth data set. Even so, the control unit may start making new recommendations immediately when the person begins an information retrieval task. The control unit may for this purpose utilize the search intent estimation model which assigns relevance values to additional text items.

In other words, the methods described in the embodiments of this disclosure may all be performed simultaneously once an information retrieval task is under way. Criteria for information retrieval can be continuously generated and updated as the person proceeds in her task, new documents can be continuously recommended based on the most recent criteria, relevance values can continuously be assigned to secondary text items if the fifth data set is insufficient by itself, and continuously updated criteria for information retrieval can be generated from relevance values associated either with primary items exclusively (when the fifth data set is sufficient), or with both primary and secondary text items (when the fifth data set is insufficient).

The fifth data set may never reach a sufficient reliability level while the person performs the information retrieval task. This may be because the quantifying unit does not assign very high relevance values to any set of recorded functional brain imaging potentials, or because the person aborted the information retrieval task before a sufficiently large fifth data set could be gathered. In such cases too, the control unit may supplement the fifth data set with relevance values for additional text items with the help of a search intent estimation model.

Through the search intent estimation model, the control unit may assign relevance values to secondary text items which the person has not viewed. In other words, no functional brain imaging measurement data may be available for these secondary text items. A search intent estimation model may be constructed in many different ways.

The exemplary search intent estimation model described below is based on the fact that primary text items in the fifth data set and their relevance values indicate the topic of the information retrieval task with reasonable accuracy. Secondary text items which also relate to this topic may co-occur with the primary text items in secondary documents which discuss this topic. Through the search intent estimation model, the control unit may index a document collection and calculate, for example with a linear regression, which secondary text items in the document collection co-occur most frequently together with the primary text items to which the quantifying unit assigned relevance values (or the highest relevance values).

For example, the primary text items “matter” and “neutrons” are relevant to the topic “Atom”. Based on the relevance values assigned to these primary text items, the control unit may determine that secondary text items, for example “atom” and “nucleus”, must also be relevant for the information retrieval task because they frequently co-occur with the primary text items mentioned above in a given set of secondary documents.

To implement the search intent estimation model, the control unit may first index a set of secondary documents comprising j documents by constructing a text item-document i×j matrix K with i secondary text items and j secondary documents. The matrix K therefore comprises i text item vectors. Each vector corresponds to a text item which occurs in at least one of the indexed secondary documents. The i:th text item vector may comprise j numerical coefficients kᵢ. These coefficients may, for example, indicate the occurrence frequency of this i:th text item in each of the j secondary documents. Alternatively, the coefficient could indicate the tf-idf value of the i:th text item in the set of secondary documents. The coefficient kᵢ could also be a combination (e.g. a product) of the occurrence frequency and the tf-idf value.

The control unit may stem text items using, for example, the English Porter Stemmer, or the like. Before stemming, English stop words may be removed if they appear in, for example, the Apache Lucence 4.10 stop word list. The control unit may alternatively index secondary documents with other methods than the one described above, such as bag of words representation or positional indexing.

The control unit may estimate relevance values for secondary text items based on the relevance values of the primary text items and the co-occurrence of primary and secondary text items in the secondary documents. The quantifying unit gives the relevance values r for the primary text items. These values r may, for example, lie between 0 and 1, so that text items with r=1 are most relevant.

The control unit may assume that the relevance value rᵢ of the i:th text item is a random variable with expected value E[rᵢ]=kᵢ·w, where the unknown weight vector w represents the user's intent and contains estimated relevance values for every primary and secondary text item in the secondary document collection.

The control unit may estimate the weight vector w with, for example, the LinRel algorithm. It iterates a linear regression model of the form r=wK by computing a regularized regression weight vector aᵢ for the i:th text item in K:

aᵢ=kᵢ(K^{T}K+λI)⁻¹K^{T} (3)

where I is the identity matrix, and λ is a regularization parameter set to 0.5. Then for each text item, the control unit may compute the estimated relevance value wᵢ in the current iteration by taking into account the feedback obtained so far:

$${w}_{i} = {a}_{i} \cdot {r}_{i} + \frac{c}{2} ‖ {a}_{i} ‖ \qquad ( 4 )$$

where rᵢ is the relevance value obtained from the quantifying unit, aᵢ is the regression weight vector of text item i in the data K, ∥aᵢ∥ is the L2 norm of the regression weight vector, and the constant c is used to adjust the influence of the history.

If the method present above in the third embodiment is implemented with both primary and secondary text item relevance values, the relevance value vector rᵢ in formulas (1) and (2) can be replaced with the estimated relevance value vector wᵢ.

This disclosure also relates to a computer program embodied transitory computer-readable medium having instructions that, when executed by a computing device or a data-processing system, cause the computing device or the data-processing system to perform any of the methods described above.

1. A method, comprising:
training a quantifying unit through machine learning to assign relevance values to functional brain imaging potentials measured from a person;
measuring functional brain imaging potentials from the person as the person views primary text items of a primary document;
assigning in the quantifying unit relevance values, which correspond to the functional brain imaging potentials, to the primary text items of the primary document; and
generating a criterion for an information retrieval task from the primary text items and their assigned relevance values.

2. A method according to claim 1, wherein the method further comprises:
measuring an eye fixation signal from the person as the person views the primary document; and
determining a viewed primary text item from the eye fixation signal.

3. A method for ranking a first set of secondary documents according to relevance, said method comprising:
training a quantifying unit through machine learning to assign relevance values to functional brain imaging potentials measured from a person;
measuring functional brain imaging potentials from the person as the person views primary text items in a primary document;
assigning in the quantifying unit relevance values corresponding to the functional brain imaging potentials to the primary text items of the primary document;
generating a criterion for an information retrieval task from the primary text items and their assigned relevance values;
determining, based on the criterion, a relevance score for secondary documents in the first set, and
ranking the secondary documents in the first set based on their relevance scores.

4. A method according to claim 3, wherein the relevance score is based on the occurrence of the primary text items in the secondary document and the relevance values of said primary text items.

5. A method according to claim 3, the method further comprising:
indexing a second set of secondary documents;
assigning relevance values to secondary text items in the secondary documents based on the co-occurrence of primary and secondary text items in the secondary documents; and
basing the relevance score on the occurrence of primary text items and secondary text items in the secondary document and the relevance values of said primary and secondary text items.

6. An apparatus, comprising:
a control unit;
a screen; and
a functional brain imaging measurement device,
wherein the control unit comprises a quantifying unit, and wherein
the quantifying unit is configured through machine learning to assign relevance values to functional brain imaging potentials measured from a person;
the functional brain imaging measurement device is configured to measure functional brain imaging potentials from the person as the person views primary text items of a primary document on the screen;
the quantifying unit is configured to assign relevance values, which correspond to the functional brain imaging potentials, to the primary text items of the primary document; and wherein
the control unit is configured to generate a criterion for an information retrieval task from the primary text items and their assigned relevance values.

7. An apparatus according to claim 6, wherein the apparatus also comprises an eye-tracking device, and wherein
the eye-tracking device is configured to measure an eye fixation signal from the person as the person views the primary document;
the control unit is configured to determine a viewed primary text item from the eye fixation signal.

8. An apparatus according to claim 6, wherein
the control unit is configured to determine, based on the criterion, relevance scores for a first set of secondary documents,
the control unit is configured to rank the secondary documents in the first set based on their relevance scores.

9. An apparatus according to claim 8, wherein the relevance score is based on the occurrence of the primary text items in the secondary document and the relevance values of said primary text items.

10. An apparatus according to claim 8, wherein
the control unit is configured to index a second set of secondary documents;
the control unit is configured to assign relevance values to one or more secondary text items based on co-occurrence of primary and secondary text items in the second set of secondary documents; and
the relevance score is based on the occurrence of the one or more primary text items and secondary text items in the secondary document and the relevance values of said primary and secondary text items.

11. A computer program embodied on a non-transitory computer-readable medium having instructions that, when executed by a computing device or a data-processing system, cause the computing device or the data-processing system to perform the method according to claim 1.

12. An apparatus according to claim 7, wherein
the control unit is configured to determine, based on the criterion, relevance scores for a first set of secondary documents,
the control unit is configured to rank the secondary documents in the first set based on their relevance scores.

13. An apparatus according to claim 12, wherein the relevance score is based on the occurrence of the primary text items in the secondary document and the relevance values of said primary text items.

14. An apparatus according to claim 12, wherein
the control unit is configured to index a second set of secondary documents;
the control unit is configured to assign relevance values to one or more secondary text items based on co-occurrence of primary and secondary text items in the second set of secondary documents; and
the relevance score is based on the occurrence of the one or more primary text items and secondary text items in the secondary document and the relevance values of said primary and secondary text items.
